(19) United States
(12) Patent Application Publication
(10) Pub. No.: US 2021/0390618 A1
(43) Pub. Date: Dec. 16, 2021

(54) Financial Risk Assessment

(71) Applicant: The Financial Risk Group Inc., Cary, NC (US)

(72) Inventors: Donald James Erdman, Raleigh, NC (US); Rory Thomas Cullen, Milford, NH (US); John Clayton Bell, Cary, NC (US)

(73) Assignee: The Financial Risk Group Inc., Cary, NC (US)

(21) Appl. No.: 16/902,493

(22) Filed: Jun. 16, 2020

(51) Int. Cl. G06Q 40/02; G06Q 40/06; G06F 3/048

(52) U.S. Cl. CPC G06Q 40/025; G06F 3/048; G06Q 40/06

(57) ABSTRACT

A system receives asset data indicating assets that have an uncertainty contributing to a financial risk of a portfolio. The system controls a multi-stage financial risk estimate process by determining a first portion and a second portion of the asset data; and computing, for the first portion, a first stage of the process. The system computes a second stage of the process for the first portion in an overlapping time period as computing the first stage for the second portion. The system, responsive to a completion of all computations of the process for the first portion, aggregates a computed risk according to the process for the first portion with any previously computed risks for other portions of the asset data besides the first and second portion. The system outputs an estimate for the financial risk for the portfolio before completing the process for the second portion.

### BACKGROUND

A company or individual may hold many assets that contribute to a financial portfolio. For example, the assets may include cash-flow sources, interest in property, contractual obligations for payment, etc. These assets may have uncertainty that contributes to a financial risk of the portfolio. For example, the value of these assets may fluctuate in response to different factors like unemployment rate or changes in underlying volatility or prices. Financial risk of a portfolio is often estimated or evaluated for a variety of purposes including for determining market or capital risk or for regulatory purposes such as financial or insurance reporting. It is often a time-consuming and memory intensive process for computers to compute financial risk for a portfolio because of the number of calculations, so the computations are performed as a batch process with no early visibility to a user if errors occur in the computations.

### SUMMARY

In an example embodiment, a computer-implemented method comprises receiving asset data indicating assets in a portfolio and one or more perturbed risk factors. Each asset is a physical or financial asset that has an uncertainty that contributes to a financial risk of the portfolio. The computer-implemented method comprises controlling a multi-stage financial risk estimate process by determining a first portion of the asset data, wherein the first portion comprises indications of one or more assets in the portfolio; and computing, for the first portion, a first stage of the multi-stage financial risk estimate process. The multi-stage financial risk estimate process is based on the one or more perturbed risk factors. The controlling a multi-stage financial risk estimate process comprises determining a second portion of the asset data. The second portion comprises indications of one or more assets in the portfolio that are different assets than any assets associated with the first portion. The controlling a multi-stage financial risk estimate process comprises computing a second stage of the multi-stage financial risk estimate process for the first portion in an overlapping time period as computing the first stage of the multi-stage financial risk estimate process for the second portion. The controlling a multi-stage financial risk estimate process comprises, responsive to a completion of all computations of the multi-stage financial risk estimate process for the first portion, generating an aggregated computed financial risk by aggregating a computed financial risk according to the multi-stage financial risk estimate process for the first portion with any previously computed risks for other portions of the asset data besides the first and second portion. The computer-implemented method comprises generating a generated confidence indication indicating a confidence of the aggregated computed financial risk to estimate the financial risk of the portfolio. The computer-implemented method comprises, responsive to the generated confidence indication, outputting an estimate for the financial risk for the portfolio before completing the multi-stage financial risk estimate process for the second portion.

In another example embodiment, a computing device is provided. The computing device includes, but is not limited to, a processor and memory. The memory contains instructions, that when executed by the processor, control the computing device to implement the computer-implemented methods described herein.

In another example embodiment, a computing system is provided. The computing system includes, but is not limited to, a processor and memory. The memory contains instructions that when executed by the processor control the computing system to implement the computer-implemented methods described herein.

In another example embodiment, a computer-program product tangibly embodied in a non-transitory machine-readable storage medium is provided. The computer-program product includes instructions to cause a computing device or system to implement the computer-implemented methods described herein.

Other features and aspects of example embodiments are presented below in the Detailed Description when read in connection with the drawings presented with this application.

### BRIEF DESCRIPTION OF THE DRAWINGS

FIG. 1 illustrates an example block diagram of a system for outputting an estimate for a financial risk of a portfolio in at least one embodiment.

FIG. 2 illustrates an example flow diagram for outputting an estimate for a financial risk of a portfolio in at least one embodiment.

FIG. 3 illustrates an example flow diagram for controlling a multi-stage financial risk estimate process in at least one embodiment.

FIGS. 4A-4D illustrate an example graphical user interface for outputting an estimate for a financial risk of a portfolio in at least one embodiment.

FIG. 5 illustrates an example block diagram of a system for outputting an estimate for a financial risk of a portfolio in at least one embodiment.

FIGS. 6A-6C illustrate an example graphical user interface for visibility into a multi-stage financial risk estimate process in at least one embodiment.

FIG. 7 illustrates an example block diagram for controlling a multi-stage financial risk estimate process in at least one embodiment.

FIG. 8 illustrates an example block diagram for a node in at least one embodiment.

### DETAILED DESCRIPTION

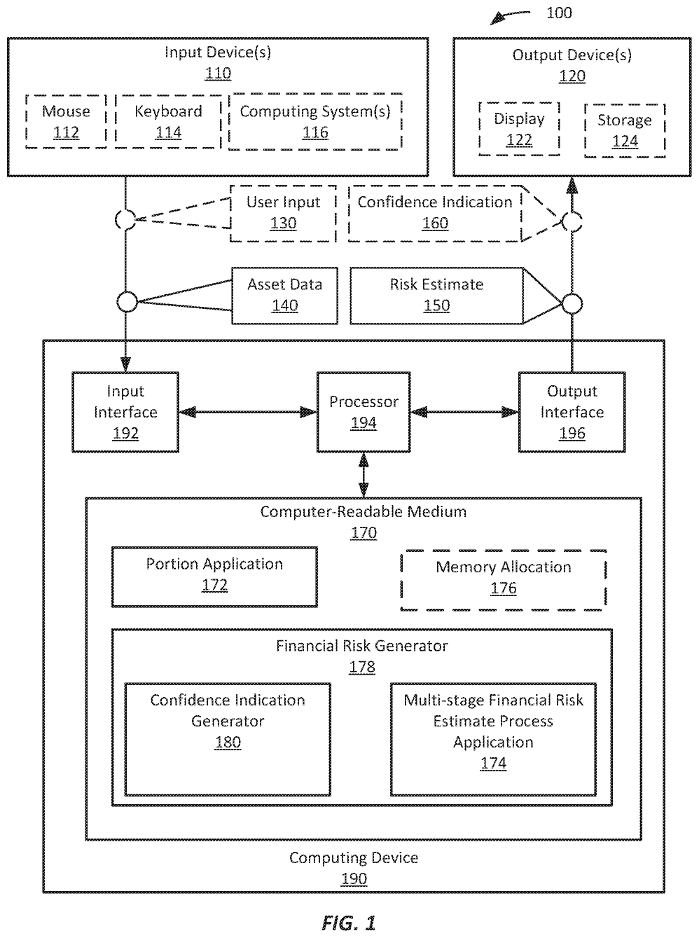

FIG. 1 illustrates an example block diagram of a system 100 for outputting an estimate for a financial risk of a portfolio (e.g., an expected loss or value of a portfolio). The system 100 can generate an estimate of the results of a financial risk analysis well before the analysis completes for all asset data 140 indicating assets in a portfolio.

FIG. 1 shows a block diagram of a system 100 in at least one embodiment of the present technology. The system 100 includes a computing device 190, an input device 110, and an output device 120. The system is configured to exchange information between the computing device 190 and input device 110 and between the computing device 190 and output device 120 (e.g., via wired and/or wireless transmission). For example, a network (not shown) can connect or communicably couple one or more devices of system 100 to one or more other devices of system 100. In one or more embodiments, the system 100 is useful for outputting to output device 120 a risk estimate 150. In some embodiments, the output device 120 may be one or more of a display device 126, a printer 128 and/or another device not shown (e.g., storage device, buffer or analysis computing device).

Computing device 190 includes an input interface 192, an output interface 196, a computer-readable medium 170, and a processor 194. In other embodiments, fewer, different, and additional components can be incorporated into computing device 190.

The computing device 190 receives asset data 140 indicating assets in a portfolio from input device 110 via input interface 192. An asset in the portfolio may be a physical or financial asset that has an uncertainty that contributes to a financial risk of the portfolio (e.g., uncertainty from market fluctuation). The portfolio can include a collection of portfolios sourced from different financial institutions (e.g., banks, savings and loan associations, credit unions, and brokerage firms). Alternatively, or additionally, the asset data received by input interface 192 includes perturbed risk factors (e.g., states of the market and/or assumptions) for analyzing the assets. For example, a perturbed risk factor could be related to an assumption for an interest value, and this perturbed risk factor could be used to analyze the interest value's effect on mortgages.

In one or more embodiments, the input device 110 is one or more computing systems 116 (e.g., physical or virtual servers, cloud computers or database systems for storing and accessing the asset data). Alternatively, or additionally the input device 110 includes one or more devices for user control (e.g., to provide user input 130 or to access asset data). For instance, the input device 110 could include one or more of a mouse 112 or a keyboard 114. Alternatively, or additionally, the input device 110 includes a display, a track ball, a keypad, one or more buttons, a sensor, a phone, etc.

The computing device 190 outputs information to output device 120 via output interface 196. Output interface 196 provides an interface for outputting information (e.g., risk estimate 150 or a confidence indication 160 indicating a confidence of a computed financial risk to estimate the financial risk of the portfolio) for review by a user and/or for use by another application or device or multiple applications or devices. For example, output interface 196 interfaces with various output technologies such as a display 122, or other devices for user review such as a printer. Additionally, or alternatively, output interface 196 interfaces with various output technologies such as storage 124 for access by a user, application or device.

In an alternative embodiment, the same interface supports both input interface 192 and output interface 196. For example, a touch screen provides a mechanism for user input and for presentation of output to the user. Alternatively, the input interface 192 has more than one input interface that uses the same or different interface technology. Alternatively, or additionally, the output interface 196 has more than one output interface that uses the same or different interface technology.

Computer-readable medium 170 is an electronic holding place or storage for information so the information can be accessed by processor. Computer-readable medium 208 can include, but is not limited to, any type of random access memory (RAM), any type of read only memory (ROM), any type of flash memory, etc. such as magnetic storage devices (e.g., hard disk, floppy disk, magnetic strips), optical disks (e.g., compact disc (CD), digital versatile disc (DVD)), smart cards, flash memory devices, etc.

Processor 194 executes instructions (e.g., stored at the computer-readable medium 170). The instructions can be carried out by a special purpose computer, logic circuits, or hardware circuits. In one or more embodiments, processor 194 is implemented in hardware and/or firmware. Processor 194 executes an instruction, meaning it performs or controls the operations called for by that instruction. The term “execution” is the process of running an application or the carrying out of the operation called for by an instruction. The instructions can be written using one or more programming language, scripting language, assembly language, etc. Processor 194 operably couples with input interface 192, with output interface 196 and with computer-readable medium 170 to receive, to send, and to process information. Processor 194 in one or more embodiments can retrieve a set of instructions from a permanent memory device and copy the instructions in an executable form to a temporary memory device that is generally some form of RAM.

In one or more embodiments, computer-readable medium 170 stores instructions for execution by processor 194. For example, computer-readable medium 170 could comprise instructions for a portion application 172 for determining a portion of the asset data 140. A given portion comprises indications of one or more assets in the portfolio. For instance, the assets can be randomly selected and/or selected to capture different types of assets. Where the portfolio is a collection of portfolios sourced from different financial institutions, determining a portion could comprise randomly sampling from each portfolio of the different financial institutions (e.g., sampling randomly and proportionally to their contribution to an analysis result). The source of data for the analysis can be randomly sampled without replacement to ensure the estimates of the results are statistically valid even though only a portion of the asset data is analyzed. Other selections are possible (e.g., selecting assets based on their likelihood to be volatile or high valued). Alternatively, or additionally, portion application 172 stores instructions for receiving a portion of the asset data 140. In one or more embodiments, the computer-readable medium 170 optionally provides for memory allocation 176 for allocating memory for storing one or more portions of asset data 140 (e.g., queues for holding the asset data 140 during processing).

In one or more embodiments, computer-readable medium 170 could comprise instructions for a financial risk generator 178 for generating an estimate of a financial risk (e.g., outputting an estimate for the financial risk for the portfolio for a first portion of the asset data 140 before completing the multi-stage financial risk estimate process for a second portion of the asset data 140). Traditional risk generators performed analysis of all of asset data as a batch process without human interaction or visibility into the process.

In one or more embodiments, the financial risk generator 178 has a multi-stage financial risk estimate process application 174 for controlling a multi-stage financial risk estimate process (e.g., one mapped from a batch process). The multi-stage financial risk estimate process may be based on the one or more perturbed factors for analyzing the asset data 140. For instance, the multi-stage financial risk estimate process may provide computations based on or incorporating assumptions of specific changes in the values of the portfolio's assets or changes in key factors (e.g., a change in the interest rate). The multi-stage financial risk estimate process may comprises one or more computations for estimating a value or price for a given asset in the portfolio; estimating a value or price for a given physical asset in the portfolio; estimating an exposure for a financial risk; and estimating a mitigation for a financial risk.

The financial risk estimate process application 174 can, for instance, determine portions of asset data 140 for entering the multi-stage financial risk estimate process, compute for a given portion, a stage of the process, and aggregate computed financial risk according to the process for a given portion with any previously computed risks for other portions of the asset data 140. The multi-stage financial risk estimate process can advantageously provide user visibility into the risk estimation. Portions can also be streamed through the stages to alleviate any greater time demands from this approach. For instance, the financial risk estimate process application 174 can compute a second stage of the multi-stage financial risk estimate process for a first portion in an overlapping time period as computing a first stage of the multi-stage financial risk estimate process for the second portion. In this way, the first portion may be used to estimate the financial risk for a whole portfolio even though all the asset data 140 has not been analyzed.

In one or more embodiments, the financial risk generator 178 has a confidence indication generator 180 for generating a confidence indication 160 indicating a confidence of a computed financial risk to estimate the financial risk of the portfolio (e.g., a current aggregation of computed financial risk for portions of the asset data 140).

In one or more embodiments, the financial risk generator 178 outputs an estimate for the financial risk for the portfolio responsive to the confidence indication 160 (e.g., risk estimate 150 is output with the confidence indication 160 or is output after meeting a certain confidence threshold or level). For instance, one or more embodiments generate an estimate of the results of a financial risk analysis well before the analysis completes for all the asset data, and the estimates of the results are provided with statistically based confidence intervals for a user to assess those estimates.

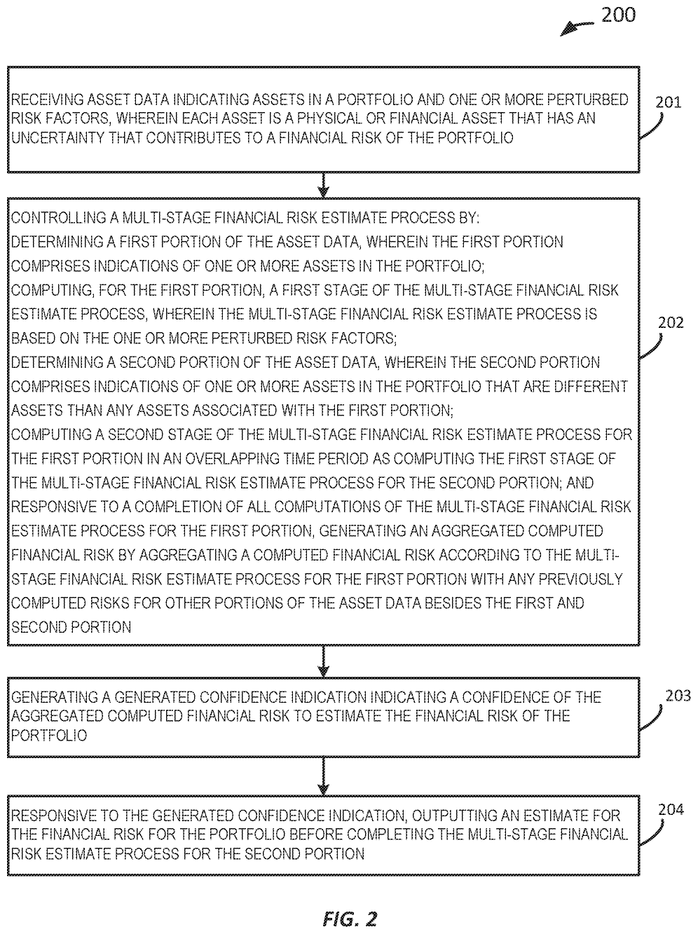

In one or more embodiments, the system 100 implements embodiments described herein (e.g., a method 200 shown in FIG. 2) for outputting an estimate for a financial risk of a portfolio.

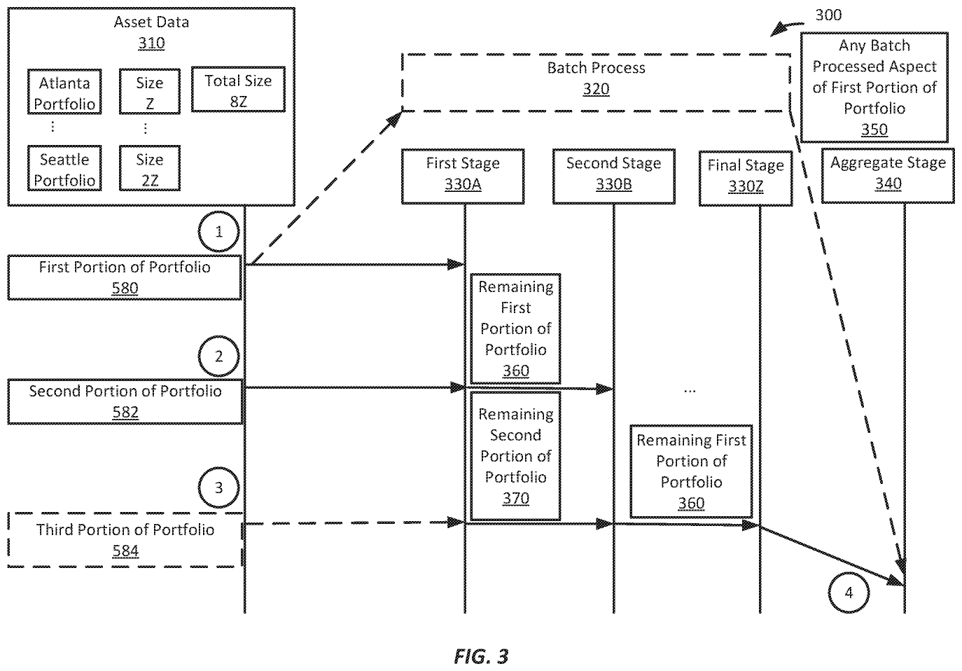

FIG. 2 illustrates an example method 200 for outputting an estimate for a financial risk of a portfolio. FIG. 3 illustrates an example flow diagram 300 for controlling a multi-stage financial risk estimate process according to the method 200.

The method 200 of FIG. 2 comprises an operation 201 for receiving asset data indicating assets in a portfolio and one or more perturbed risk factors. Each asset is a physical or financial asset that has an uncertainty that contributes to a financial risk of the portfolio. FIG. 3 shows example asset data 310. In this example, the asset data 310 comprises a collection of portfolios sourced from different financial institutions in different cities (e.g., Atlanta and Seattle). The asset data 310 may also have information regarding the assets like a representation of, or information for determining, the size of the portfolio or the overall combined portfolio size (e.g., the Seattle portfolio is twice the size of the Atlanta portfolio, but ¼ the size of the entire portfolio). This representation may be based on a data size for assets represented by the asset data 310 and may be normalized to account for variations in size for different asset types.

The method 200 of FIG. 2 comprises an operation 202 for controlling a multi-stage financial risk estimate process. Controlling the multi-stage financial risk estimate process comprises determining a first portion of the asset data. The first portion comprises indications of one or more assets in the portfolio.

For instance, as shown in FIG. 3, a computing device determines a first portion 580 of the asset data 310 at operation 1. The first portion comprises indications of one or more assets in the portfolio. A computing device (e.g., computing device 190) may determine an indication of an amount of data from each of different portfolios of the collection of portfolios.

The method 200 of FIG. 2 comprises an operation 202 for controlling a multi-stage financial risk estimate process that comprises computing, for the first portion, a first stage of the multi-stage financial risk estimate process. The multi-stage financial risk estimate process is based on the one or more perturbed risk factors. As shown in FIG. 3, at operation 1 the first portion 580 is at a first stage 330A of a multi-stage financial risk estimate process.

The method 200 of FIG. 2 comprises an operation 202 for controlling a multi-stage financial risk estimate process that comprises determining a second portion of the asset data. The second portion comprises indications of one or more assets in the portfolio that are different assets than any assets associated with the first portion (i.e., assets selected for a portion are not available for other portions). Controlling a multi-stage financial risk estimate process comprises computing a second stage of the multi-stage financial risk estimate process for the first portion in an overlapping time period as computing the first stage of the multi-stage financial risk estimate process for the second portion. For instance, the stages may take different amounts of time to complete or may be started or ended at different times.

For instance, as shown in FIG. 3 at an operation 2, a second portion 582 is determined and computed at the first stage 330A while remaining data of the first portion of the portfolio 360 is computed at a second stage 330B. This process can continue if there are remaining portions of the asset data or until stopped (e.g., in response to user input or processing failure). For example, in an option 3, an optional third portion 584 is computed at the first stage 330A, while remaining data of the second portion of portfolio 370 is computed at a second stage 330B and remaining data of the first portion of the portfolio 360 is computed at a final stage 330Z. This process had only 3 stages merely for illustration, and more or less stages is possible (e.g., dependent on the financial risk analysis or perturbed risk factors). All the stages may not operate on all aspects of the data of the portion (e.g., some data may be processed according to a batch process 320 or may be of a type not relevant to a particular stage).

The method 200 of FIG. 2 comprises an operation 202 for controlling a multi-stage financial risk estimate process that comprises, responsive to a completion of all computations of the multi-stage financial risk estimate process for the first portion, generating an aggregated computed financial risk by aggregating a computed financial risk according to the multi-stage financial risk estimate process for the first portion with any previously computed risks for other portions of the asset data besides the first and second portion.

For instance, as shown in FIG. 3 at an operation 4, the risk associated with portions that have completed the stages of the financial risk estimate process (or batch process 320) are aggregated at an aggregation stage 340.

The method 200 of FIG. 2 comprises an operation 203 for generating a generated confidence indication indicating a confidence of the aggregated computed financial risk to estimate the financial risk of the portfolio.

The method 200 of FIG. 2 comprises an operation 204 for responsive to the generated confidence indication, outputting an estimate for the financial risk for the portfolio before completing the multi-stage financial risk estimate process for the second portion.

In one or more embodiments, the estimate is used for generating a report for regulation of the portfolio, or for estimating the Market or Credit risk for the portfolio. For instance, the estimate may be used for regulatory purposes such as for a Comprehensive Capital Analysis and Review (CCAR) analysis, International Financial Reporting Standard (IFRS9), International Insurance Reporting Standard (IFRS17), International regulatory accord (Basel II, III, IV), Current Expected Credit Losses (CECL), Capital Requirements Directive (CRD IV), and GAAP Long Duration Targeted Improvements (LDTI). Alternatively, or additionally, the estimate may be used for market or Credit risk purposes for internal business planning such as analyzing trading risk capital, limit management, liquidity management, trading approvals, economical capital, capital planning, book and deal valuation, and what-if analysis.

If the data is drawn randomly from the input, the results for the portfolio (e.g., for regulation or risk analysis) can be forecasted before the process is complete for all asset data for the portfolio. For example, given an input portfolio of one million instruments, after one percent of the portfolio is processed a computing device has access to a sample of size of 10,000 instruments from which to estimate the final numbers. If the process takes ten hours to run, after about 5 minutes a user could get a reasonably good estimate of final numbers (e.g., for detecting errors in calculations or inputs).

In FIG. 3, if the asset data 310 is input data from a single source table, then that table can be randomly sampled by any number of well-known methods to determine the portions. If there are multiple sources of input data, then a random sample requires a higher level of algorithmic complexity.

The brute force method is to combine all the data into a single table to apply the simple case. The disadvantage of this method is that it is batch in nature and will greatly increase the size of the data as the fields in the resulting table become a union of the fields in the parent tables. An alternative approach is to sample from the tables proportionally to each table's number of contributing items in each table.

A computing device may determine a respective contribution proportion from each of the different portfolios of the collection of portfolios to the collection of portfolios. For instance, the Atlanta portfolio contributes ⅛ of the assets to the total portfolio and the Seattle portfolio contributes ¼. The computing device may determine, based on a respective contribution proportion, a sample size for each portfolio of the different portfolios of the collection of portfolios for randomly sampling to derive first portion 580. The computing device may determine portions in other ways (e.g., simply randomly selecting from all the asset data, sequentially accessing asset data, or other ways described herein), but randomly sampling based on a contribution of the portfolios to a collection of portfolios map provide greater statistical confidence in estimating a financial risk of the collection.

Given the example in FIG. 3 with one portfolio having Z observations, and the other with 2*Z observations, an example algorithm would take, on average, two samples from the latter table for every one sample from the former table.

This process is generalizable to the following algorithm for more than two tables:

(1) Calculate the proportions for each table. The sum of the proportions can be normalized to equal 1.
(2) Accumulate the proportions to generate cut points for the interval [0,1].
(3) Generate a random uniform [0,1] draw.
(4) Determine which table to draw from based on the cut points in step 2.
(5) Draw randomly from that table.
(6) Repeat steps 3-5 until all the data has been streamed through the multi-stage process.

In one or more embodiments, the multi-stage financial risk estimate process is mapped from computations of a batch financial risk process 320. The batch financial risk process comprises computer instructions for receiving all the asset data 310 and processing all the computations for financial risk assessment on the asset data 310 as a group.

In some cases, it may not be desired to have all the assets processed using a multi-stage financial risk estimate process and data pertaining to some assets may be processed by the batch process 320 in parallel with the multi-stage financial risk estimate process. For instance, in one or more embodiments, determining the first portion 580 of the asset data 310 comprises excluding data indicating at least one asset of the asset data that is a type associated with a batch process. In this case, a computing device synchronizes a computed risk according to the batch process with computed financial risk according to the multi-stage financial risk estimate process for the first portion 580 at the aggregate stage 340.

The stages of the multi-stage financial risk estimate process are flexibly organized in that some stages may be implemented in parallel or stages may have parallel operations. For instance, a computing device may synchronize output from multiple stages of the multi-stage financial risk estimate process for the first portion as input to another stage of the multi-stage financial risk estimate process for the first portion. As another example, the multi-stage financial risk estimate process may comprises multiple computation variations in a given stage for a given asset type (e.g., to alternate different analysis approaches or variations due to different asset types). A computing device (or one or more decision nodes) may assign asset data indicating a first asset of a portion to a first variation of the multiple computation variations in the given stage; and assign asset data indicating a second different asset of the portion to a second variation of the multiple computation variations in the given stage.

Data in a given portion may be streamed flexibly (e.g., dependent on computational needs of a stage) such that some asset information may be streamed one at a time from one stage to the next, blocks of asset information of a portion may be streamed, or the entire portion may be held and streamed to the next stage once assets are complete, or a combination of one or more of these approaches.

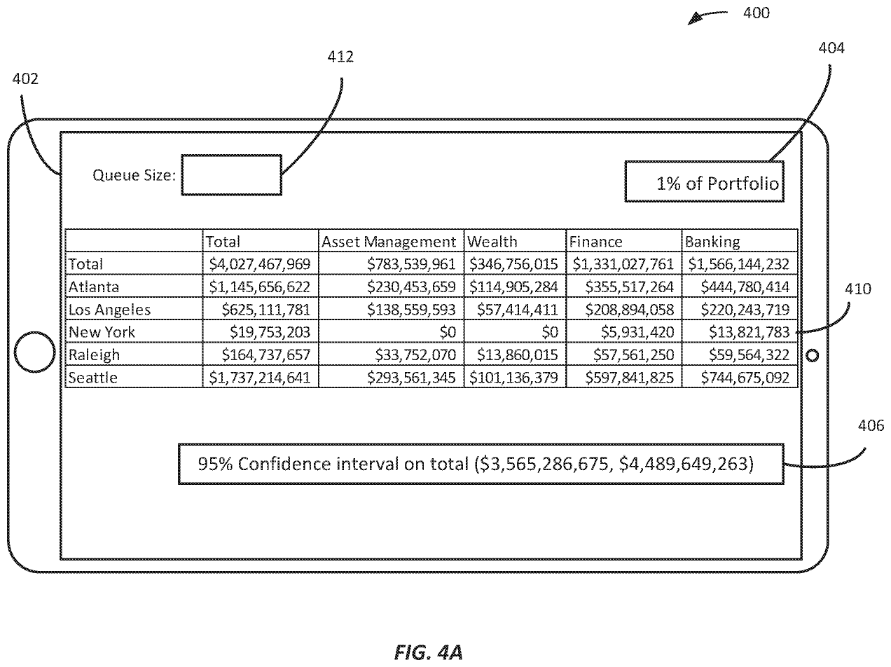

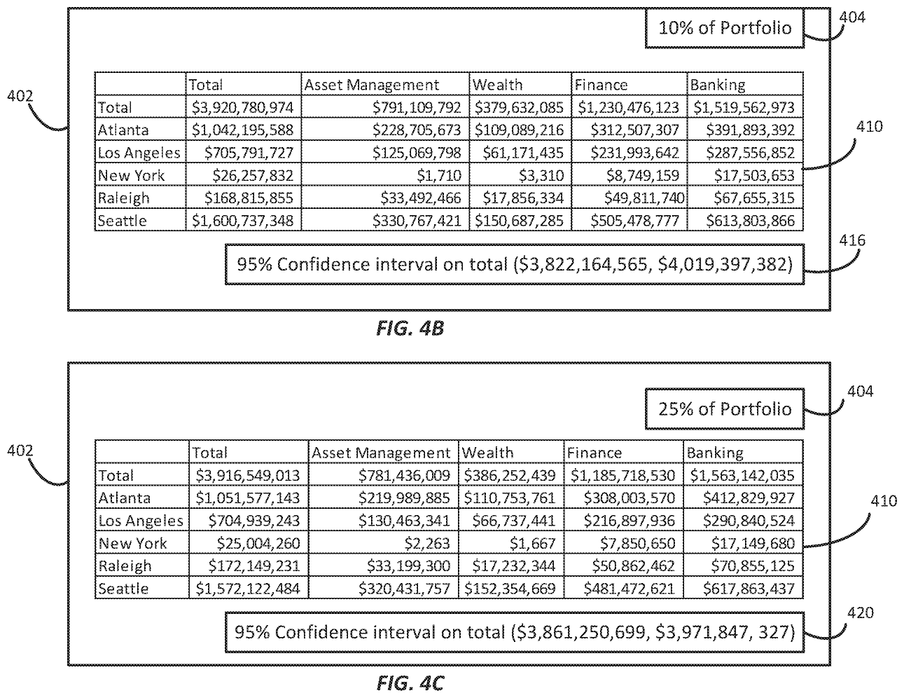

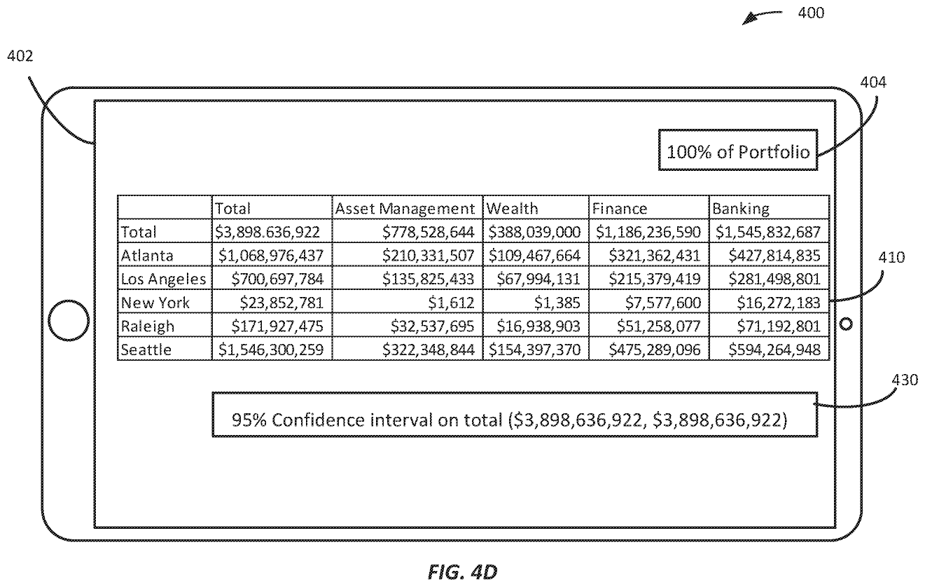

FIGS. 4A-4D illustrate an example graphical user interface 402 on computing device 400 (e.g., a computing device described herein) for controlling a multi-stage financial risk estimate process and/or displaying an output of an estimate for a financial risk of a portfolio. In FIG. 4A, there is a text box 412 for controlling a queue size for memory holding data waiting to be processed by the next stage. The user can enter information in text box 412 to control how quickly the asset data is processed or how large a portion size will be.

In FIG. 4A, one percent of the portfolio has been processed as shown in box 404. Table 410 shows an evaluation of the present value of the assets for various locations from Atlanta to Seattle and various types of assets from asset management, wealth, finance, and banking. The computing device 400 is able to combine different sources of input to ensure the statistical validity of the estimated results.

An estimated value is given for each of these portfolios, and the portfolio as a whole in table 410. In output 406, the user is presented with the confidence of an estimate for the portfolio as a whole, and a range of expected variation on the total value. In this case, based on only one present of the assets of the portfolio, the computing device 400 is able to give a valuation of the portfolio with 95% confidence. The computing device 400 has the size of the original input data and uses that to calculate the proportion of the input data that has been processed and scale the numbers accordingly. The estimate for the financial risk extrapolates the aggregated computed financial risk to the portfolio.

The computing device 400 generated a confidence indication with an upper confidence limit ($4,489,649,263) that is a sum of the estimate for the financial risk for the portfolio ($4,027,467,969) and a delta. The computing device 400 generated a confidence indication comprising a lower confidence limit ($3,565,286,675) that is a difference between the estimate for the financial risk for the portfolio and the delta.

In this case, delta is calculated according to the below equation:

$$delta = {t}_{α \text{/} 2} T √ ( \frac{1}{n} {\sum }_{1}^{n} {( {x}_{i} - μ )}^{2} ( 1 - p ) ) ,$$

where:

t_{α/2}=a t-statistic based on the desired confidence interval accuracy a between 0 and 1 exclusively. Typically, a 95% confidence interval is desired so a would be 0.05.

T=total count of asset data;

p=the proportion of asset data that has completed the multi-stage financial risk estimate process;

n=Number of assets completed;

x=Value of interest;

i=i-th asset value;

μ=Mean of the values;

This computation accounts for the size of the population sampled from based on a known finite size of the population. The variance goes to zero as the sample size approaches the population size.

In FIGS. 4B and 4C, one or more subsequent portions have completed the multi-stage financial risk estimate process. Responsive to controlling completion of all computations of the multi-stage financial risk estimate process for these subsequent portions, computing device 400 generates an updated confidence indication accounting for the subsequent portions. Responsive to the updated confidence indication, the computing device 400 outputs an updated estimate for the financial risk for the portfolio. In FIG. 4B the textbox 404 has been updated to show that 10 percent of the portfolio has been analyzed and shows an updated confidence interval in box 416. In FIG. 4C the textbox 404 has been updated to show that 25 percent of the portfolio has been analyzed and shows an updated confidence interval in box 420. In this example, the portion size was not customized or changed during the processing of the portions but could be in other examples.

In one or more embodiments, the computing device 400 determines an amount of asset data that has completed the multi-stage financial risk estimate process; and generates the confidence indication to account for the amount of asset data that has completed the multi-stage financial risk estimate process. As shown in FIGS. 4B and 4C, the box 420 has a tighter window than box 416 on the estimate as the computing device 400 has analyzed more of the data than in FIG. 4B.

In one or more embodiments, the computing device 400 controls completion of all computations of the multi-stage financial risk estimate process for each portion of multiple portions where all of the asset data is comprised in the multiple portions. Each portion of the multiple portions comprises different asset data than any other portion of the multiple portions. In FIG. 4D the textbox 404 has been updated to show that 100 percent of the portfolio has been analyzed.

In one or more embodiments, responsive to controlling completion of all computations of the multi-stage financial risk estimate process for each portion of multiple portions, the computing device 400 outputs an updated estimate for the financial risk for the portfolio; and generates a confidence indication indicating zero anticipated change in the updated estimate for the financial risk for the portfolio. In this case, FIG. 4D shows the same number for the upper and lower confidence interval in box 430. In other cases, this could have been displayed differently (e.g., text indicating 100 percent confidence or zero anticipated change).

Embodiments herein are applicable to other types of analysis than shown in FIGS. 4A-4B. For instance, the embodiments are applicable to analysis types shown in Table 1.

TABLE 1

| Analysis Type | Description |
|---|---|
| VaR | Value at Risk |
| MtM | Mark to Market |
| Historical Simulation | Use history to simulate possible future states |
| EVT or EVA | Extreme Value Theory |
| PFE | Potential Future Exposure |
| Scenario Analysis | Use of scenarios to predict losses or gains |
| Sensitivity Analysis | Determine the rate and magnitude of change |
| | given a change in the underlying asset |
| Expected Loss | Losses occurring from a borrower that may default |
| Expected Credit Loss | A probability weighted estimate of credit losses |
| ALLL | Allowance for Loan and Lease Losses |
| Regulatory Capital | Capital set aside for losses and determined by |
| | regulatory bodies |
| RWA | Risk Weighted Assets |
| Economic Capital | Measure of risk in terms of capital |

Embodiments herein have been described with reference to a computing device for simplicity, but embodiments herein can be implemented alternatively by a system (e.g., a system with different nodes for computing different stages of a multi-stage financial risk estimate process).

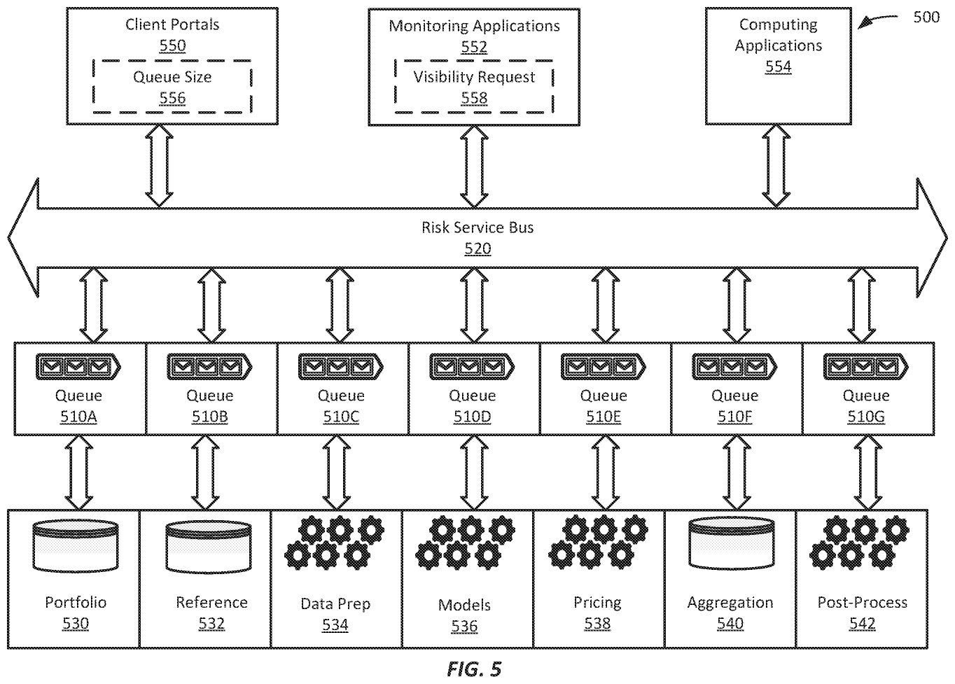

FIG. 5 illustrates an example block diagram of a system for outputting an estimate for a financial risk of a portfolio. In this example, to determine the total enterprise-wide financial risks and total economic capital for banks or insurance institutions, their portfolios are evaluated and aggregated. This computation involves various operations including an operation 530 to obtain a portfolio. The data of the portfolio may be cleansed to remove confidential information or to standardize the formatting. The portfolio may be enriched as for instance an operation 532 to map references to the portfolio. The asset data may be prepped in an operation 534 (e.g., to score the counterparties such as how likely it is that a person will default on a loan). Models (e.g., stochastic models) may be used in an operation 536 (e.g., to compute net exposure or mitigations). Assets are evaluated or priced in an operation 538. Scenarios or simulations may be used to evaluate instruments or counterparties. Results for the assets are aggregated in an operation 540. Post-processing may occur in an operation 554 (e.g., to produce a result for a dashboard or graphical user interface). More, or less, or different operations are possible.

Each of these operations may have multiple sub-operations. For example, evaluating the financial instruments may involve cashflow generation, net present value (NPV) calculations, additional output variable generation, currency conversion, and holding adjustments.

Traditionally these operations are done as a batch process using the entire portfolio at each step in the process. That is, the portfolio is completely processed in operation 530 before it can be used in operation 532. Operation 532 must be finished before operation 534 starts. More typically operations 534-542 are done as one large batch sub-step. This ends in the following usual problems: if the batch process fails, disproportionately large amount of time is lost, there is no failover or resuming of a stopped process, there are no results until the entire portfolio is finished, and batch jobs of this nature usually consume most of memory and other resources on a machine so that a second run cannot be performed.

One or more embodiments addresses these shortcomings. Data can be streamed or passed in portions. If data is streamed it could be an event (e.g. an event of an event stream processing engine), a single observation from a data set, or a position in a portfolio. A streaming process can be an ordered graph of worker nodes that perform some sequential operation on data passing through the process. Embodiments are not limited to the usual streaming paradigm in which the parts that are streamed are the smallest, indivisible parts of data. The invention allows for streaming blocks of data (e.g., half of the size of the original data). In the example shown in FIG. 5, data structures (queues 510) hold output of each stage of the multi-stage financial risk estimate process.

These data structures connect the operations and allow for an abstract interface between the nodes in an operation process, which allows the nodes to use their own programming language. In one or more embodiments, the controlling of the multi-stage financial risk estimate process comprises executing code in a first computer language and the completing all computations of the multi-stage financial risk estimate process for the first portion comprises executing code in one or more other computer languages different from the first computer language (e.g., a computer language of a node performing an operation of the multi-stage financial risk estimate process). This can help integrate embodiments with existing financial systems.

In one or more embodiments, the queue's length is user configurable and determines a memory footprint and throughput of the process. For instance, after a computing system receives (e.g., via a graphical user interface 402) input from a user indicating a size of a queue for a given data structure of the output of a given stage of the multi-stage financial risk estimate process, the computing device allocates memory based on the size of the queue for the given data structure. In one or more embodiments, a batch process already had data structures that are repurposed as queues 510 for holding steamed or portioned data.

Nodes in the computing system 500 may perform a set of operations on individual instruments from the portfolio. Furthermore, these nodes can be multiple workers distributed across multiple machines. This enables parallel processing not just across the process but within each operation 530-542.

Using a queueing system allows for reliability, ability to resume, and to scale up the process on the fly. Items can stay in a queue 510 until a node indicates it has completely processed the input instance and acknowledged it is done. If a worker node goes down, it can be restarted and resumed where it left off. Queuing systems have persistence to disk for the queues to ensure resume-ability even when the machine goes down.

The advantages of a multi-stage financial risk estimate process over a batch process approach can be thought of by considering a batch process as a streamed process with a large, single object being moved along the stream. Consider a single threaded batch process with N steps. Take the batch process and split the input data into two approximately equal sections and run them one after another. Specifically, start the second set of data on the first step of the process after the first set of data completes this step and begins on the second step. This enables additional parallel processing and the first stream will output results before the whole process is finished.

To increase the number of pieces, split the input data into the number of available CPUs, K. If K is less than N, the CPUs could be fully utilized. Generally, this does not happen because the processes become I/O bound since each process is reading and writing to the disk. This process also becomes difficult to restart if the machine goes down as a user can only avoid recomputing the parts that are completely done.

In the example in FIG. 5, a queue 510 is between the nodes of the process and queue 510 can save the intermediate states/results of the system and allow for more efficient restarts. The queue 510 could also (or instead of) keep the intermediate results in memory so that each step in the process does not have to read and write results to the disk. This improves the CPU utilization and further speeds up total execution time of the process. Ultimately it is a trade off in memory usage versus\ reliability and/or performance which can be selected by the user.

In one or more embodiments, the multi-stage financial risk estimate process is computed by one or more different computing systems, each computing system of the one or more different computing systems comprising one or more network connected nodes; and a controller node determines that a given node in the one or more computing systems has erred in computing a stage of the multi-stage financial risk process. The controller node may make this determination, for instance, in response to user input or an error message from the node. The controller node can retrieve the given portion and restart the stage of the multi-stage financial risk estimate process for the given portion without interrupting computations occurring on multiple portions in other stages of the multi-stage financial risk estimate process for the other portions.

Data in queues 510 can be pushed or provided on request to the nodes. For instance, a node may request data that is either a lookup for each instrument or is needed as block of data for processing efficiency. This is what is done in process if a “join” is used in the usual data processing manner. This is typically handled by an index, database or an in-memory hash. There can also be a risk service bus 520 for exchanging data with nodes implementing the operations 530-542.

The risk service bus 520 may also connect the computing system with client portals 550. The client portals 550 can be used by a user to control the computing system 500 (e.g., to provide a queue size 556). The risk service bus 520 may also be used to connect to various monitoring applications 552 for monitoring performance of the computing system 500 (e.g., to restart a stage of the computing system in response to an error or to provide visibility to a user). The risk service bus 520 might also connect to various computing applications 1554 for utilizing information from the computing system 500 (e.g., a generated risk estimate).

In one or more embodiments, the computing system 500 receives a visibility request 558 from a client node (e.g., from client portal 550 or monitoring applications 552) for visibility into a given stage of the multi-stage financial risk estimate process. The computing system 500 responsive to the visibility request, sends information (e.g., one or more statistics) indicating performance of computations in the given stage across portions of the asset data computed by the given stage. Additionally, or alternatively, the computing system 500 displays, in a graphical user interface, a visibility indication of computation progress for respective computations on portions of the asset data for respective stages of the multi-stage financial risk estimate process.

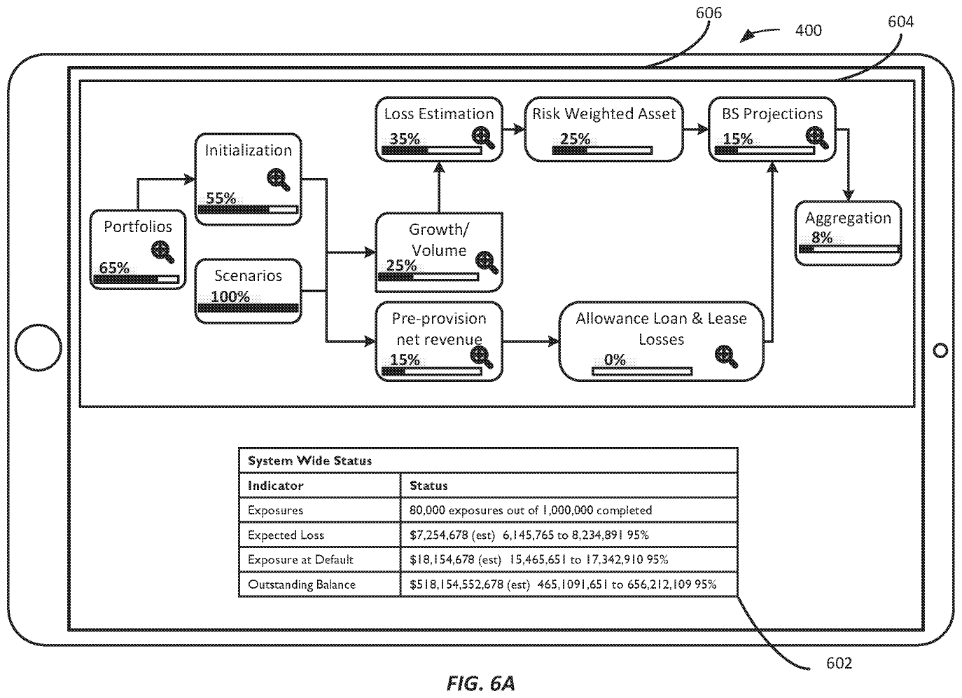

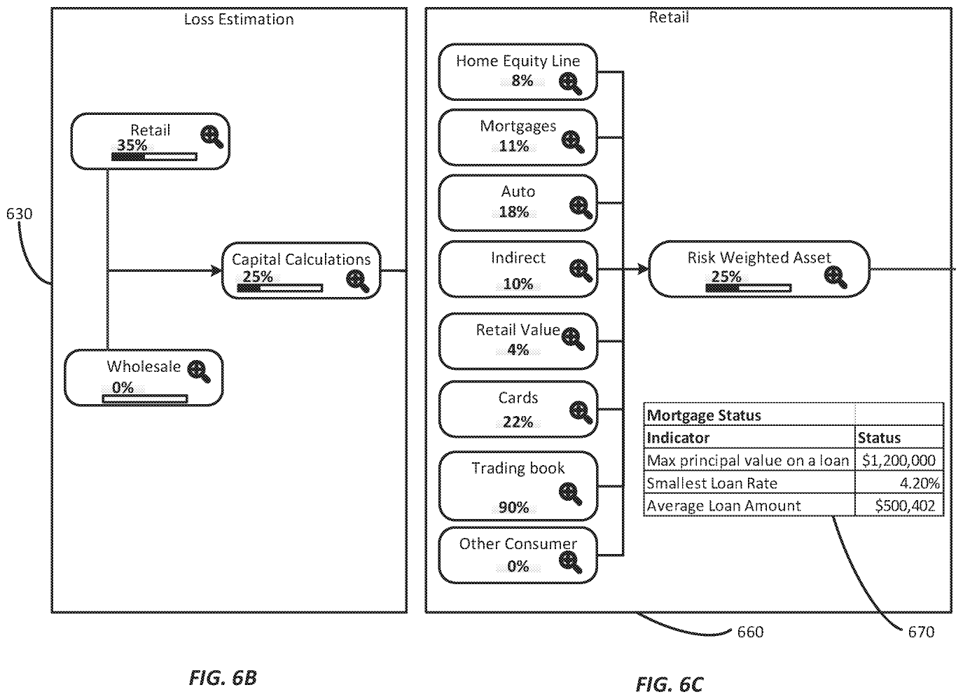

FIGS. 6A-6C illustrate an example graphical user interface 606 on computing device 400 for visibility into a multi-stage financial risk estimate process. In one or more embodiments, a computing device or system (e.g., computing device 400) provides information on a multi-stage financial risk estimate process (e.g., for detecting problems in the pipeline computing risk information). The information could indicate statistics such as a maximum value for computations of data according to the given stage or process (e.g., maximum principal value on a loan, largest probability of default, largest loss given default, and a top 10 list). Alternatively, or additionally, the information could indicate statistics such as a minimum value for computations of data according to the given stage (e.g., a smallest loan rate, smallest time to default, a bottom 100 list). Alternatively, or additionally, the information could indicate statistics regarding an average such as outliers or an average value for computations of data according to the given stage (e.g., an average loan amount). Alternatively, or additionally, the information could indicate statistics such as a count of data processed by the given stage.

In FIG. 6A, the computing device 400 displays a table 602 with system wide information regarding a multi-stage financial risk estimate process shown graphically in dashboard 604. As shown in the table 602 an indicator of exposures is provided showing a status of 80,000 exposures out of 1 million completed. The systemwide status also shows a currently estimated expected loss with a confidence interval, shows an exposure at default estimate also with the confidence interval, and an estimated portfolio balance or value (e.g., an outstanding balance) with confidence interval Dashboard 604 also shows a current progress of each stage of calculations and in the multi-stage process. For instance, the user can see that 100 percent of the scenarios have been processed by the multi-stage financial risk process estimate. However, the user can also see that only 35 percent of loss estimation calculations have occurred on 65 percent of the asset data in the portfolios. Using dashboard 604 a user can drill down into one of various stages shown (e.g., the user can select loss estimation).

As shown in FIGS. 6B-6C, if the operations in a stage of the multi-stage financial risk estimate process are hierarchical, an aggregation engine could track progress at finer levels of the hierarchy to provide individualized progress and more accuracy for the drill downs in the data. Dashboard 630 shows an example of drilling down into the loss estimation computations and dashboard 660 furthers drills down into retail computations.

As shown in FIG. 6C, the asset data analyzed may indicate any type of assets such as a cashflow indication (e.g., cashflow from auto loans); a physical asset pertaining to payment obligations or receipt of cash flows (e.g., value of retail assets securing a loan); a financial instrument pertaining to payment obligations (e.g., credit card contracts); and a financial instrument pertaining to ownership (e.g., mortgage loans). As shown, each portion processed can comprise multiple types of the assets in the portfolio, and the computing device or system is performing calculations on the different assets. In this way, the financial risk estimate can better capture the complexity of the portfolio.

A user can select a stage to see statistics regarding that stage. For instance, as shown in FIG. 6C the user has selected the mortgage stage. The dashboard 660 is populated with the Table 670 showing the statistics pertaining to the mortgages stage. In this example, there is an indicator of the maximum principle value on a loan, a smallest loan interest rate, and an average loan amount. A user may use this information to determine a problem with calculations in this stage. For instance, a user may determine that a loan with an extreme loan amount was incorrectly entered into the portfolio. The user then can correct this entry and restart the calculations.

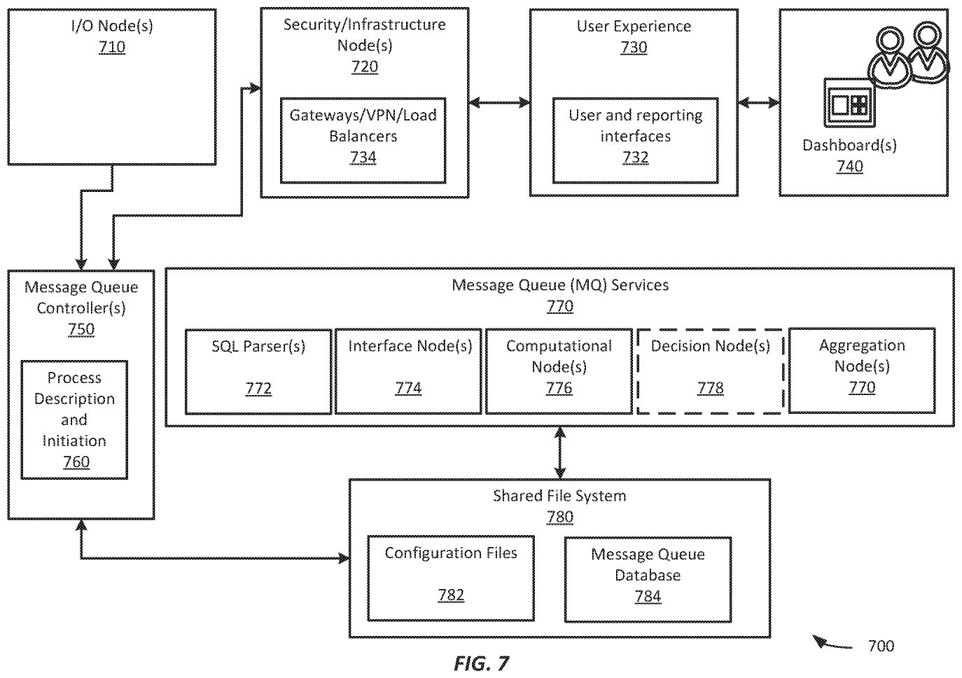

FIG. 7 illustrates an example block diagram for controlling a multi-stage financial risk estimate process.

In this example, the system 700 is used to migrate an existing batch system which performs an enterprise-wide financial risk computation to a streaming version. In conversion, some existing process steps in the batch process are further broken down or combined with other steps. The data that is the input and output to these steps is used to define a data schema for all the tables in the current batch system. This schema provides a foundation for the new streaming system. Current tables in the batch process are used for queues in the streaming system (e.g., persisted tables). For instance, when the output is persisted to flat files, a directory by JobID could be created. When the tables are persisted to a database, a jobID field can be added to all the output tables. The tables that are really queues have the queue name suffixed by the jobID to allow multiple processes to run simultaneously.

The system 700 comprises one or more message queue controllers 750 or brokers for controlling the integration with an existing computation system. Computing nodes implement message queue services 770 (e.g., computational nodes 776 perform computations on asset data). The message queue service 770 and the message queue controller 750 have a shared file system 780. The shared file system 780 can store configuration files 782 for configuring the network according to the configuration files 782 and a message queue database 784 for storing asset data queued for processing according to a multi-stage financial risk estimate process.

For instance, the configuration files 782 may indicate a data schema and node information on available computing nodes (e.g., a list of node identifiers, a specification of how many threads each node can use, a list of machines the node can run on for horizontal scaling, whether a node is a subprocess, or made of a collection of nodes, etc.). When a job runs, an instantiation of a network is created according to the data schema and node information. For example, a thread count >1 creates multiple workers for a specific step. Multiple machines associated with a node instruct the job to start these nodes on multiple computers. Nodes could be dynamically created on machines in a cloud.

In this example, everything was not streamed. The configuration files 782 specify synchronization points to help with sections of the process that need all the data to proceed or nodes that are processing data in chunks. A predecessor node indicates to a synchronization point or a downstream node that it is done sending data.

The created network is available to user to inspect through a user interface. User experience 730 can provide user and reporting interfaces 732 for user interaction with the created network. For instance, the user and reporting interfaces 732 send and receive from dashboard 740 (e.g., a dashboard described herein). The user experience 730 can be used to start, stop, or edit options for a multi-stage financial risk estimate process instance. For instance, the user and reporting interfaces 732 can be used by a user to edit stage names and value tables. The user experience 730 can be used to monitor a running or finished process, select a node and view statistics regarding that node, drill into a subprocess, view queue contents, retrieve input and output tables (e.g., retrieve first x lines, where x is a numeral), delete old processes, set authorization rules (e.g., if a user starts a job, only that user or an administrator can view or delete the job).

Security or infrastructure node 720 connect the user experience 730 with message queue controller 750. The security or infrastructure nodes may provide gateways, virtual private network (VPN) connections, or load balancers 722 for supporting interaction with the user experience 730 and a message queue broker controller 750. I/O nodes 710 provide input to the message queue broker controller 750 (e.g., providing asset data or perturbed risk factors) For instance, the I/O nodes 710 can be used to read from a disk to provide data or write data to a disk to persist the results of computations.

In this example, Structured Query Language (SQL) Parser 772 are one or more nodes that take as input a node name, a specification of the inputs and outputs of the node, a thread count, a single SQL select statement, and a list of statistics. Inputs could be specified. The specification of the inputs and the output are name value pairs linking the queue or database table to the table references in the SQL statement. This allows to abstract out the actual table/stream names and allows to reuse the nodes. The tables mentioned in the query are mapped to the inputs by name. These tables could be database tables or a stream of data.

In this example, SQL parser 772 provides extract, transform, and load (ETL) functions. For instance, SQL parsers 772 extract statistics regarding the multi-stage financial risk estimate process (e.g., count, mean, minimum, maximum and other statistics described herein). These statistics could be available to a monitoring system to print information about the node at run time. The SQL parser 772 can stream the statistics (sampled) to a central controller that could respond to representational state transfer (REST) queries from the client (e.g., via the user experience nodes 730). Below is an example SQL code for retrieving information from user experience 730:
SELECT*FROM Customers WHERE Last_Name=‘Smith’;
SELECT ord_no, cust_name, commission AS “Commission %”,
purch_amt*commission AS “Commission” FROM salesman,orders,customer WHERE orders.customer_id=customer.customer_id AND orders.salesman_id=salesman.salesman_id AND customer.grade>=200;

In the architecture of FIG. 7, the nodes can be constructed heterogeneously using a multitude of languages including SAS, GO, Python, C# etc.

In this example, computational node 776 are one or more nodes that take as input a node name, a specification of the inputs and outputs of the node, thread count, computation functions, and an optional statistics function. The computational node 776 performs computations on data in the message queue database 784 (e.g., a stream or table) (e.g., computations related to a multi-stage financial risk estimate process described herein). The computational node may be a collection or multiple copies of a node for parallel processing or for doing different computations in different computer languages.

Interface node 774 is one or more nodes used to interface with existing systems (e.g., systems provided by SAS Institute, Inc. running SAS® code). The interface node 774 takes as input a node name, a specification of the inputs and outputs of the node, a specification of chunk sizes for the inputs, and the number of instances to run in parallel (thread count/vertical scaling). This node queues up inputs coming from streams into chunks and executes existing system code. The interface node 774 also streams the results out to the next nodes. The interface node 774 monitors indicators of completing the processing of asset data so that a last, odd sized chunk, can be processed (without waiting for a complete chunk).

In this example, optional decision node 778 is one or more nodes for a complex design. Complex designs may have, for instance, a design objective to run only a part of the multi-stage financial risk estimate process or have options that control a path through the process (e.g., Champion/Challenger switches). The decision node 778 takes as input a node name, a flag name (its value can be obtained from message queue controller 750), and a specification of the inputs and outputs of the node. The inputs are associated with one or more output queues. The outputs are tagged with a value for the flag. If all the output queues associated with an input queue are inactivated, the input queue is drained automatically. The decision node 778 could be used, for example, to decide which message queue data undergoes which computations in the multi-stage financial risk estimate process.

The message queue controller 750 comprises process description and initiation application 760 for instantiating an instance of a multi-stage financial risk estimate process. For instances, the message queue controller 750 can start the nodes on the appropriate machines (e.g., horizontal scaling), receive information provided by nodes and needed by nodes (e.g., nodes performing the message queue services 770, producer nodes 710 and security and infrastructure node 720). For example, the message queue controller 750 can collect statistics from nodes, inform nodes about predecessor nodes being done with processing, and provide values for setting options of decision node 778 (e.g., flag values).

In this example, the message queue controller 750 provides a REST application programming interface (API) for user interfaces (e.g., user experience nodes 730). The message queue controller 750 also monitors health of the system and collects information to allow for graceful restarts.

The message queue controller 750 can be used to access a data schema for configuration files 782.

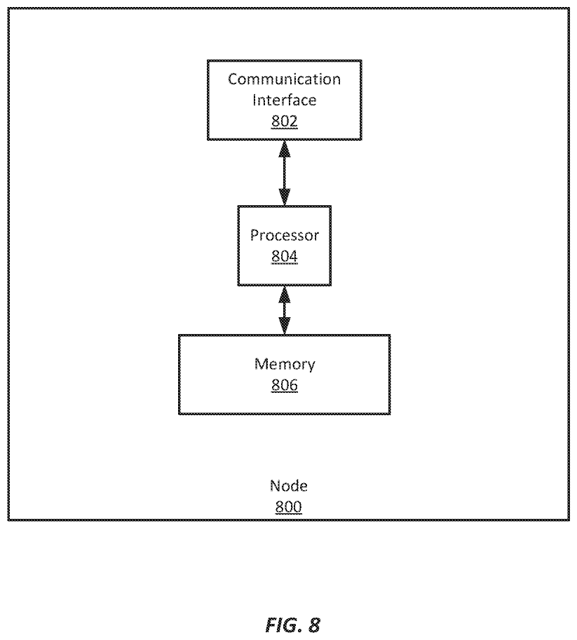

Example systems described herein utilized various computing nodes and devices (e.g., computing device 190). The computing nodes and devices can be implemented with hardware and/or software to perform the operations of embodiments described herein. For instance, FIG. 8 illustrates an example block diagram for a computing device or node 800. The node 800 includes processor 804 with one or more processing circuits (e.g., with one or more features of processor 194), a memory 806 (e.g., with one or more features of computer-readable medium 170), and one or more communication interfaces 802 (e.g., with one or more features of input interface 192 and/or output interface 196 such as sending or receiving input). The processor 804 controls the operation of the node to perform functionality described herein.

The circuits described above may comprise one or more processors, hardware circuits, firmware, or a combination thereof. The node in this regard may comprise memory that includes one or more volatile and/or non-volatile memory devices. Program code for controlling operation of the node may be stored in a non-volatile memory, such as a read-only memory or flash memory. Temporary data generated during operation may be stored in random access memory. Program code stored in memory, when executed by the processing circuit(s), causes the processing circuit(s) to perform the methods described above.

In one or more embodiments, one or more sets of instructions or applications stored in memory 806 are implemented in software (e.g., computer-readable and/or computer-executable instructions) stored in memory 806 and accessible by processor 804 for execution of the instructions. The applications can be written using one or more programming languages, assembly languages, scripting languages, etc. One or more applications stored in memory 806 can be implemented as a Web application. For example, an application can be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

One or more embodiments present processing and visibility improvements over other existing processing systems. Processing out of memory with a fixed hierarchy (e.g., Data Pools) suffered from having a fixed hierarchy and aggregation of data is not distributed. Processing with in-memory aggregations (e.g., SAS® model implementation platform) and processing with distributed in-memory (e.g., SAS® Risk or SAS® VIYA®) suffered from high resource requirements (e.g., that cannot be effectively scaled to simulation-sized problems at issue in financial risk estimation). Further they all suffered from using batch processes that process all asset data with no fail over, no resumes, no results until finished, and no visibility into the computations. Embodiments herein present novel devices, systems and graphical user interfaces that provide visibility to a user and better processing for estimating financial risk.

Embodiments herein may be carried out in other ways than those specifically set forth herein without departing from essential characteristics of the invention(s). One of ordinary skill in the art will appreciate applications beyond those presented in the examples. The present embodiments are to be considered in all respects as illustrative and not restrictive, and all changes coming within the meaning and equivalency range of the claims are intended to be embraced therein. Embodiments described with reference to singular terms such as “a node” or “a device” can mean “one or more”, and embodiments described with reference to plural terms such as “nodes” “devices” can mean “a single one”.

What is claimed is:

1. A computer-implemented method comprising:
receiving asset data indicating assets in a portfolio and one or more perturbed risk factors, wherein each asset is a physical or financial asset that has an uncertainty that contributes to a financial risk of the portfolio;
controlling a multi-stage financial risk estimate process by:
determining a first portion of the asset data, wherein the first portion comprises indications of one or more assets in the portfolio;
computing, for the first portion, a first stage of the multi-stage financial risk estimate process, wherein the multi-stage financial risk estimate process is based on the one or more perturbed risk factors;
determining a second portion of the asset data, wherein the second portion comprises indications of one or more assets in the portfolio that are different assets than any assets associated with the first portion;
computing a second stage of the multi-stage financial risk estimate process for the first portion in an overlapping time period as computing the first stage of the multi-stage financial risk estimate process for the second portion; and
responsive to a completion of all computations of the multi-stage financial risk estimate process for the first portion, generating an aggregated computed financial risk by aggregating a computed financial risk according to the multi-stage financial risk estimate process for the first portion with any previously computed risks for other portions of the asset data besides the first and second portion;
generating a generated confidence indication indicating a confidence of the aggregated computed financial risk to estimate the financial risk of the portfolio; and
responsive to the generated confidence indication, outputting an estimate for the financial risk for the portfolio before completing the multi-stage financial risk estimate process for the second portion.

2. The computer-implemented method of claim 1, wherein the method further comprises:
controlling completion of all computations of the multi-stage financial risk estimate process for the second portion;
responsive to controlling completion all computations of the multi-stage financial risk estimate process for the second portion, generating an updated generated confidence indication updating the generated confidence indication to account for the second portion; and
responsive to the updated generated confidence indication, outputting an updated estimate for the financial risk for the portfolio.

3. The computer-implemented method of claim 1,
wherein the method comprises controlling completion of all computations of the multi-stage financial risk estimate process for each portion of multiple portions, wherein all of the asset data is comprised in the multiple portions, and each portion of the multiple portions comprises different asset data than any other portion of the multiple portions; and
responsive to controlling completion of all computations of the multi-stage financial risk estimate process for each portion of multiple portions:
outputting an updated estimate for the financial risk for the portfolio; and
generating a generated confidence indication indicating zero anticipated change in the updated estimate for the financial risk for the portfolio.

4. The computer-implemented method of claim 1,
wherein the portfolio is a collection of portfolios sourced from different financial institutions; and
wherein determining the first portion comprises randomly sampling from each portfolio of the different financial institutions.

5. The computer-implemented method of claim 4, wherein determining the first portion comprises:
determining an indication of an amount of data from each of different portfolios of the collection of portfolios;
determining a respective contribution proportion from each of the different portfolios of the collection of portfolios to the collection of portfolios; and
determining, based on a respective contribution proportion, a sample size for each portfolio of the different portfolios of the collection of portfolios for the randomly sampling.

6. The computer-implemented method of claim 1,
wherein the method further comprises receiving a visibility request from a client node for visibility into a given stage of the multi-stage financial risk estimate process; and
responsive to the visibility request, sending one or more statistics indicating performance of computations in the given stage across portions of the asset data computed by the given stage.

7. The computer-implemented method of claim 6, wherein the one or more statistics comprise one or more of:
a maximum value for computations of data according to the given stage;
a minimum value for computations of data according to the given stage;
an average value for computations of data according to the given stage; and
a count of data processed by the given stage.

8. The computer-implemented method of claim 1,
wherein the multi-stage financial risk estimate process is computed by one or more different computing systems, each computing system of the one or more different computing systems comprising one or more network connected nodes; and
wherein the method further comprises determining that a given node in the one or more computing systems has erred in computing a stage of the multi-stage financial risk process for a given portion of the asset data and retrieving the given portion and restarting the stage of the multi-stage financial risk estimate process for the given portion without interrupting computations occurring on multiple portions in other stages of respective multi-stage financial risk estimate process for the multiple portions.

9. The computer-implemented method of claim 1,
wherein the controlling the multi-stage financial risk estimate process comprises executing code in a first computer language and the completing all computations of the multi-stage financial risk estimate process for the first portion comprises executing code in one or more other computer languages different from the first computer language.

10. The computer-implemented method of claim 1,
wherein the receiving the asset data comprises determining a total amount of asset data; and
wherein generating the generated confidence indication comprises:
determining an amount of asset data that has completed the multi-stage financial risk estimate process; and
generating the generated confidence indication to account for the amount of asset data that has completed the multi-stage financial risk estimate process.

11. The computer-implemented method of claim 10,
wherein generating the generated confidence indication comprises generating:
an upper confidence limit that is a sum of the estimate for the financial risk for the portfolio and a delta;
a lower confidence limit that is a difference between the estimate for the financial risk for the portfolio and the delta; or
both;
wherein the estimate for the financial risk extrapolates the aggregated computed financial risk to the portfolio;
wherein
$$delta = {t}_{α \text{/} 2} T √ ( \frac{1}{n} {\sum }_{1}^{n} {( {x}_{i} - μ )}^{2} ( 1 - p ) ) ,$$
where:
t_{α/2}=a desired confidence interval accuracy between 0 and 1 exclusively;
T=total count of asset data;
P=a proportion of asset data that has completed the multi-stage financial risk estimate process;
n=Number of assets completed;
x=Value of interest;
i=i-th value; and
μ=Mean of the values.

12. The computer-implemented method of claim 1,
wherein the method further comprises displaying a graphical user interface;
wherein the receiving the asset data comprises receiving, via the graphical user interface, input from a user indicating one or more sources for receiving the asset data; and
wherein outputting the estimate for the financial risk for the portfolio comprises displaying, in the graphical user interface, the estimate for the financial risk for the portfolio and the generated confidence indication.

13. The computer-implemented method of claim 12,
wherein the multi-stage financial risk estimate process comprises a data structure for output of each stage of the multi-stage financial risk estimate process;
wherein the method further comprises receiving, via the graphical user interface, input from the user an indication of a size of a queue for a given data structure of the output of a given stage of the multi-stage financial risk estimate process; and
wherein the computing a multi-stage financial risk estimate process comprises allocating memory based on the size of the queue for the given data structure.

14. The computer-implemented method of claim 12, wherein the method further comprises displaying, in the graphical user interface, a visibility indication of computation progress for respective computations on portions of the asset data for respective stages of the multi-stage financial risk estimate process.

15. The computer-implemented method of claim 1,
wherein the multi-stage financial risk estimate process is mapped from computations of a batch financial risk process; and
wherein the batch financial risk process comprises computer instructions for receiving all the asset data and processing the computations on the asset data as a group.

16. The computer-implemented method of claim 1,
wherein determining the first portion of the asset data comprises excluding data indicating at least one asset of the asset data that is a type associated with a batch process for computing financial risk contributed by the at least one asset; and
wherein the generating the aggregated computed financial risk comprises synchronizing a computed risk according to the batch process with the computed financial risk according to the multi-stage financial risk estimate process for the first portion.

17. The computer-implemented method of claim 1,
wherein the method further comprises synchronizing output for all of the first portion from one or more stages of the multi-stage financial risk estimate process for the first portion as input to another stage of the multi-stage financial risk estimate process for the first portion.

18. The computer-implemented method of claim 1, wherein computing, for the first portion, a given stage of the multi-stage financial risk estimate process comprises controlling computations for the given stage on a stream of data for each asset of the first portion.

19. The computer-implemented method of claim 1,
wherein the assets in the portfolio comprise assets of different types, including one or more of:
a cashflow indication;
a physical asset pertaining to payment obligations or receipt of cash flows;
a financial instrument pertaining to payment obligations; and
a financial instrument pertaining to ownership; and
wherein at least the first portion or the second portion comprises multiple types of the assets in the portfolio.

20. The computer-implemented method of claim 1, wherein the multi-stage financial risk estimate process comprises multiple computation variations in a given stage for a given asset type, and the controlling the multi-stage financial risk estimate process comprises:
assigning, by one or more decision nodes, first asset data indicating a first asset of the first portion to a first variation of the multiple computation variations in the given stage; and
assigning second asset data indicating a second asset of the first portion to a second variation of the multiple computation variations in the given stage, wherein the second asset is different from the first asset.

21. The computer-implemented method of claim 1,
wherein the multi-stage financial risk estimate process comprises one or more computations for:
estimating a value or price for a given asset in the portfolio;
estimating a value or price for a given physical asset in the portfolio;
estimating an exposure for a financial risk; and
estimating a mitigation for a financial risk.

22. A computer-program product tangibly embodied in a non-transitory machine-readable storage medium, the computer-program product including instructions operable to cause a computing system to:
receive asset data indicating assets in a portfolio and one or more perturbed risk factors, wherein each asset has an uncertainty that contributes to a financial risk of the portfolio;
control a multi-stage financial risk estimate process by:
determining a first portion of the asset data, wherein the first portion comprises indications of one or more assets in the portfolio;
computing, for the first portion, a first stage of the multi-stage financial risk estimate process, wherein the multi-stage financial risk estimate process is based on the one or more perturbed risk factors;
determining a second portion of the asset data, wherein the second portion comprises indications of one or more assets in the portfolio that are different assets than any assets associated with the first portion;
computing a second stage of the multi-stage financial risk estimate process for the first portion in an overlapping time period as computing the first stage of the multi-stage financial risk estimate process for the second portion; and
responsive to a completion of all computations of the multi-stage financial risk estimate process for the first portion, generating an aggregated computed financial risk by aggregating a computed financial risk according to the multi-stage financial risk estimate process for the first portion with any previously computed risks for other portions of the asset data besides the first and second portion;
generate a generated confidence indication indicating a confidence of the aggregated computed financial risk to estimate the financial risk of the portfolio; and
responsive to the generated confidence indication, output an estimate for the financial risk for the portfolio before completing the multi-stage financial risk estimate process for the second portion.

23. A computing system comprising processor and memory, the memory containing instructions executable by the processor wherein the computing system is configured to:
receive asset data indicating assets in a portfolio and one or more perturbed risk factors, wherein each asset has an uncertainty that contributes to a financial risk of the portfolio;
control a multi-stage financial risk estimate process by:
determining a first portion of the asset data, wherein the first portion comprises indications of one or more assets in the portfolio;
computing, for the first portion, a first stage of the multi-stage financial risk estimate process, wherein the multi-stage financial risk estimate process is based on the one or more perturbed risk factors;
determining a second portion of the asset data, wherein the second portion comprises indications of one or more assets in the portfolio that are different assets than any assets associated with the first portion;
computing a second stage of the multi-stage financial risk estimate process for the first portion in an overlapping time period as computing the first stage of the multi-stage financial risk estimate process for the second portion; and
responsive to a completion of all computations of the multi-stage financial risk estimate process for the first portion, generating an aggregated computed financial risk by aggregating a computed financial risk according to the multi-stage financial risk estimate process for the first portion with any previously computed risks for other portions of the asset data besides the first and second portion;
generate a generated confidence indication indicating a confidence of the aggregated computed financial risk to estimate the financial risk of the portfolio; and
responsive to the generated confidence indication, output an estimate for the financial risk for the portfolio before completing the multi-stage financial risk estimate process for the second portion.
